(19) United States
(12) Patent Application Publication
(10) Pub. No.: US 2017/0059764 A1
(43) Pub. Date: Mar. 2, 2017

(54) LIGHT GUIDE PLATE, BACKLIGHT UNIT AND DISPLAY DEVICE

(71) Applicants: BOE Technology Group Co., Ltd., Beijing (CN); Beijing BOE CHATANI Electronics Co., Ltd., Beijing (CN)

(72) Inventor: Tianlong LI, Beijing (CN)

(21) Appl. No.: 14/915,401

(22) PCT Filed: Aug. 21, 2015
(86) PCT No.: PCT/CN2015/087812

§ 371 Date: Feb. 29, 2016

(30) Foreign Application Priority Data
Apr. 20, 2015 (CN) 201510189058.X

(51) Int. Cl. F21V 8/00

(52) U.S. Cl. CPC G02B 6/0016; G02B 6/0051; G02B 6/0053; G02B 6/0031; G02B 6/0093; G02B 6/0095

(57) ABSTRACT

A light guide plate (02), a backlight unit (05) and a display device (09) are disclosed. The backlight unit (05) includes a light guide plate (02), a frame (051) and a lamp group. The light guide plate (02) includes: a light-out surface (M), a gridded surface (N) configured as being opposite to the light-out surface (M) and having gridded dots disposed on it, and side surfaces (W) intersecting both the light-out surface (M) and the gridded surface (N), gridded dots are disposed on a non-light-in surface of the side surfaces (W) of the light guide plate (02). The frame (051) is disposed outside the side surfaces (W) of the light guide plate (02). The lamp group is configured for emitting light, such that the light is reflected by the gridded surface (N) as well as the side surfaces (W) having gridded dots disposed thereon of the light guide plate (02), and then the reflected light emits from the light-out surface (M). As it is easy to bond side reflective sheets (052) to the side surfaces (W) of the light guide plate (02), reflection effect to the light is improve and the light utilization efficiency is increased.

### FIELD OF THE ART

Embodiments of the invention relate to a light guide plate, a backlight unit and a display device.

### BACKGROUND

With the development of liquid crystal display technologies, Liquid Crystal Displays (LCDs) are widely used in the display field. A LCD realizes the display function by forming an electric field between two electrically conductive glass substrates so as to drive non-self-illuminating liquid crystal molecules located in-between the two electrically conductive glass substrates. A Backlight Unit (BLU) is a light source disposed behind the LCD for providing backlight for the LCD. The liquid crystal molecules modulate light emitted by the BLU to allow the LCD to display images or characters. Therefore, light emitting effect of the BLU directly influences the display effect of the LCD.

### SUMMARY

Embodiments of the invention provides a light guide plate, a backlight unit and a display device, making it easy to bond side reflective sheets to side surfaces of the light guide plate, thereby increasing the reflection effect and the light utilization efficiency.

At least one embodiment of the invention provides a light guide plate, which comprises a light-out surface, a gridded surface configured as being opposite to the light-out surface and having gridded dots disposed thereon, and side surfaces intersecting both the light-out surface and the gridded surface; gridded dots are disposed on non-light-in surfaces of the side surfaces of the light guide plate.

As an example, the side surfaces of the light guide plate are perpendicular to the light-out surface thereof; or the side surfaces of the light guide plate have inclination angles relative to the light-out surface thereof.

As an example, the gridded dots are made of a material having a high reflectivity without light absorption.

Another embodiment of the invention provides a backlight unit, which comprises a light guide plate, a frame and a lamp group.

The light guide plate comprises: a light-out surface, a gridded surface configured as being opposite to the light-out surface and having gridded dots disposed thereon, and side surfaces intersecting both the light-out surface and the gridded surface, wherein gridded dots are disposed on non-light-in surfaces of the side surfaces of the light guide plate.

The frame is disposed outside the side surfaces of the light guide plate.

The lamp group is configured for emitting light, such that the light is reflected by the gridded surface as well as the side surfaces having gridded dots disposed thereon of the light guide plate, and then the reflected light leaves from the light-out surface of the LGP.

As an example, in the backlight unit provided by an embodiment of the invention, the side surfaces of the light guide plate are perpendicular to the light-out surface, or the side surfaces of the light guide plate have inclination angles relative to the light-out surface.

As an example, the backlight unit provided by an embodiment of the invention further comprises side reflective sheets.

Each of the side reflective sheets is disposed between the side surface of the light guide plate and the frame and configured for reflecting light emitted from the side surface of the light guide plate.

As an example, in the backlight unit provided by an embodiment of the invention, a contact surface between the frame and the side reflective sheet is parallel to the side surface of the light guide plate.

As an example, the backlight unit provided by an embodiment of the invention further comprises a bottom reflective sheet.

The bottom reflective sheet is disposed on a side of the light guide plate having the gridded surface.

As an example, the backlight unit provided by an embodiment of the invention further comprises side reflective sheets; each of the side reflective sheet is disposed between the side surface of the light guide plate and the frame and configured for reflecting light emitted from the side surface of the light guide plate.

The bottom reflective sheet and the side reflective sheets are an integral structure.

As an example, the backlight unit provided by an embodiment of the invention further comprises an optical film group and a light-shielding sheet.

The optical film group is disposed on a side of the light guide plate having the light-out surface.

The light shielding sheet is disposed at an edge of a surface of the optical film group which is away from the light guide plate, and an orthographic projection of the side surfaces of the light guide plate on the light-out surface falls within a coverage of the light-shielding sheet.

As an example, the gridded dots are made of a material having a high reflectivity without light absorption.

Still another embodiment of the invention provides a display device, which comprises a display panel and any of the above backlight units.

As an example, the display panel comprises a black sealing region arranged at peripheral regions thereof, an area of the black sealing region is larger than or equal to an area of an orthographic projection of the side surfaces of the light guide plate on the light-out surface.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a configuration of a backlight unit;

FIG. 2 schematically illustrates a configuration of a light guide plate (LGP) in accordance with an embodiment of the invention;

FIG. 3 schematically illustrates a cross section view of a LGP in accordance with an embodiment of the invention;

FIG. 4 schematically illustrates a cross section view of another LGP in accordance with an embodiment of the invention;

FIG. 5 schematically illustrates a configuration of a backlight unit in accordance with an embodiment of the invention;

FIG. 6 schematically illustrates a configuration of another backlight unit in accordance with an embodiment of the invention;

FIG. 7 schematically illustrates a configuration of still another backlight unit in accordance with an embodiment of the invention;

FIG. 8 schematically illustrates a configuration of yet another backlight unit in accordance with an embodiment of the invention; and

FIG. 9 schematically illustrates a configuration of a display device in accordance with an embodiment of the invention.

### DETAILED DESCRIPTION

In order to clearly illustrate the technical solution of the embodiments of the invention, the drawings of the embodiments will be briefly described in the following; it is obvious that the described drawings are only related to some embodiments of the invention and thus are not limitative of the invention. Based on the described embodiments herein, those skilled in the art can obtain other embodiment(s), without any inventive work, which should be within the scope of the invention.

FIG. 1 schematically illustrates a configuration of a backlight unit 01. With reference to FIG. 1, the backlight unit 01 comprises a bottom reflective sheet 011, a frame 012, a light guide plate (LGP) 013, an optical film group 014, a lamp group (not shown), a light-shielding sheet 015 and a steel frame 016. The LGP 013 comprises a light-out surface A, a gridded surface B disposed opposite to the light-out surface A and having gridded dots disposed thereon, and side surfaces intersecting both the light-out surface A and the gridded surface B. As an example, the gridded surface B is a surface with dot protrusions disposed thereon. The optical film group 014 is disposed on the same side as the light-out surface A of the LGP 013. The light-shielding sheet 015 is disposed at an edge of a surface of the optical film group 014 which is away from the LGP 013. The bottom reflective sheet 011 is disposed on the same side as the gridded surface B of the LGP 013. The frame 012 is disposed outside the side surfaces of the LGP 013, and the steel frame 016 is disposed outside the frame 012. When the backlight unit is an edge-lit backlight unit, the lamp group (not shown in FIG. 1) is disposed between the LGP 013 and the frame 012. When the backlight unit is a direct-lit backlight unit, the lamp group (not shown in FIG. 1) is disposed between the LGP 013 and the bottom reflective sheet 011. Light emitted by the lamp group passes through the LGP 013 and then emit from the light-out surface A of the LGP 013; after passing through the optical film group 014, the light incident on a display panel. The gridded surface B can reflect the light emitted by the lamp group, making rays of scattered light having different directions impinging the gridded dots to converge, thereby effectively increasing the brightness of the light-out surface A. It is known that the following methods may be used to increase the light usage and avoid light from exiting from the side surfaces of the LGP 013. On one hand, when the backlight unit 01 is of a large size, side reflective sheets are bonded to the side surfaces of the LGP 013 and used to reflect light exiting from the side surfaces of the LGP 013, such that the reflected light will emit from the light-out surface A. On the other hand, when the LGP 013 is of a smaller size, the frame 012 can reflect light exiting from the side surfaces of the LGP 013.

It is found that it is getting more and more difficult to bond side reflective sheets to the LGP, as the side surfaces of the LGP are getting ever narrower with LGPs becoming thinner. As for the frame, its performance in reflecting light is poor, due to material reasons.

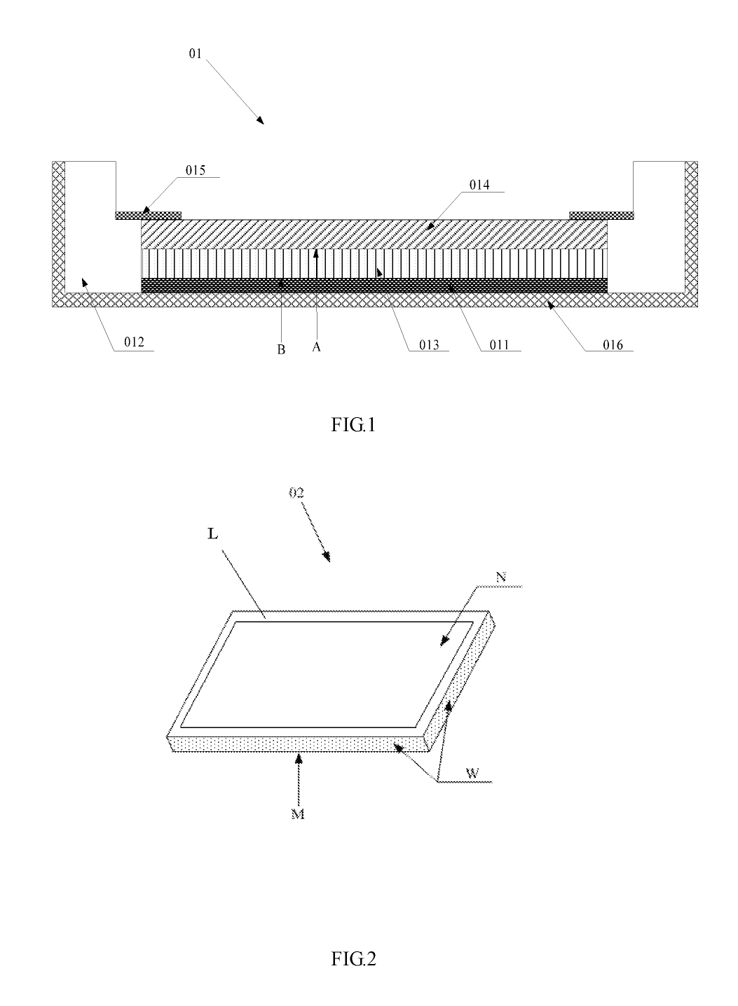

FIG. 2 schematically illustrates a configuration of a LGP 02 in accordance with an embodiment of the invention.

With reference to FIG. 2, the LGP 02 comprises a light-out surface M, a gridded surface N disposed opposite to the light-out surface M and having gridded dots disposed thereon, and side surfaces W configured as intersecting both the light-out surface M and the gridded surface N. Non-light-in surfaces (the surfaces on which the light does not incident) of the side surfaces W of the LGP 02 have gridded dots disposed thereon.

As an example, when the backlight unit is a direct-lit backlight unit, light enters the LGP 02 from a side of the LGP 02 which is opposite to the light-out surface M, that is, the light enters the LGP 02 from the gridded surface N thereof, and all side surfaces W of the LGP 2 have gridded dots disposed thereon. As an example, when the backlight unit is an edge-lit light unit, light can enter the LGP 02 from any one of the side surfaces of the LGP 02, that is, the surface will be the light-in surface of the LGP 02, and side surfaces of the LGP 02 other than the light-in surface have gridded dots disposed thereon.

The gridded dots can reflect light, making rays of scattered light having different directions impinging the gridded dots to converge, thereby effectively increasing the brightness of the light-out surface. For example, it allows the LGP 02 to emit light homogeneously by configuring density and size of the gridded dots appropriately.

The LGP provided by the embodiment disposes gridded dots on non-light-in surface of the side surfaces of the LGP, thereby reflecting light and allowing light to exit from the light-out surface of the LGP. By this means, even the side surfaces of the LGP get ever narrower, making it difficult to bond side reflective sheets to the side surfaces of the LGP, the effect of reflecting light is still realized without bonding side reflective sheets, thereby increasing the light usage efficiency.

For example, as illustrated in FIG. 2, there are void regions L, i.e., regions having no gridded dots disposed thereon, on edges of the gridded surface N. In a display device, a display panel is assembled above the LGP 02 and the display panel has a black sealing region at the peripheral regions thereof, as a result, after the display device is assembled, the black sealing region of the display panel covers the edges of the gridded surface N. In this sense, even gridded dots are disposed on the edge of the gridded surface N, such gridded dots will not reflect light anyway. Considering of the above, the void regions having no gridded dots disposed thereon are provided on the edges of the gridded surface N, thereby saving materials used for the gridded dots.

As an example, FIG. 3 schematically illustrates a cross section view of a LGP 02 in accordance with an embodiment of the invention. With reference to FIG. 3, side surfaces W of the LGP 02 are perpendicular to the light-out surface M.

As the side surfaces of the discussed LGPs are perpendicular to the light-out surface, in the embodiment of the invention, gridded dots may be directly disposed on non-light-in surfaces of the side surfaces of the LGP, thereby reflecting light. As a result. there is no need to reconfigure the LGP, and a better reflection effect is achieved.

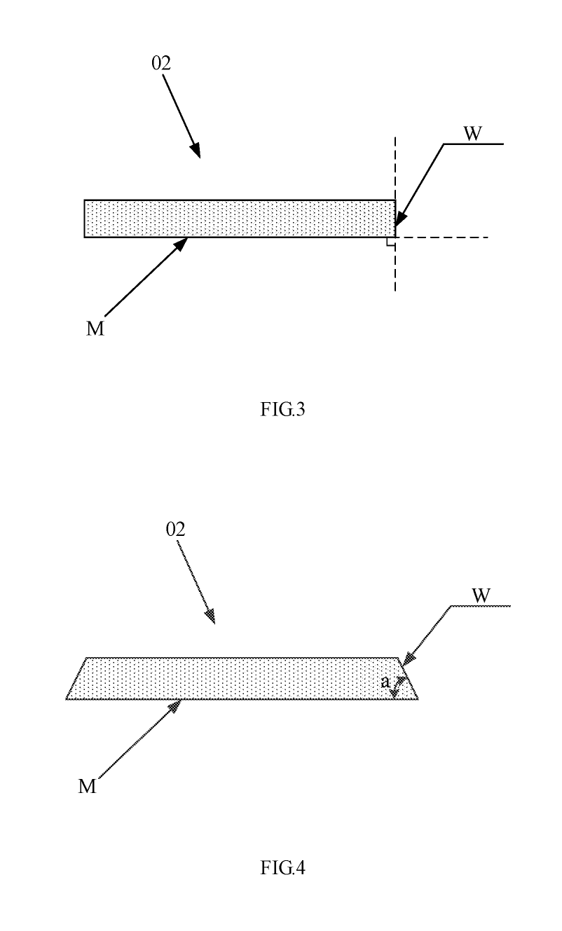

As an example, FIG. 4 schematically illustrates a cross section view of another LGP 02 in accordance with an embodiment of the invention. With reference to FIG. 4, side surfaces W of the LGP 02 have an inclination angle, which is defined as “a”, relative to the light-out surface M. The inclination angle is not equal to 90 degrees, therefore, the side surfaces W are inclined surfaces relative to the light-out surface M. Such a configuration can increase areas of the side surfaces W of the LGP 02, making it easier to bond reflective sheets to the side surfaces of the LGP 02.

As an example, the void regions on the edges of the gridded surface N of the LGP 02 may be appropriately used to make the side surfaces W which are perpendicular to the light-out surface M of the LGP to have inclination angles relative to the light-out surface M.

FIG. 4 illustrates a scenario where the inclination angle “a” is less than 90 degrees. In practical applications, the inclination angle may also be larger than 90 degrees but smaller than 180 degrees, which will not be defined in the embodiment of the invention.

According to the LGP provided by the embodiment of the invention, the light utilization efficiency is increased by disposing gridded dots on the non-light-in surfaces of the side surfaces W of the LGP 02 so as to reflect light. Moreover, according to the embodiment of the invention, the non-light-in surfaces of the side surfaces W of the LGP 02 is configured as inclined surfaces and then side reflective sheets are bonded on the side surfaces W. By this means, the side reflective sheets further reflect light, in addition to reflection by the gridded dots, thereby further increasing the light utilization efficiency.

As an example, the LGP 02 may be fabricated with a transparent acrylic material by ejection molding. Acrylic is chemically referred to as poly (methyl methacrylate) (PMMA), which has a high light transmittance and is highly shock-resistant. A LGP made with acrylic has an excellent light-guide performance. As an example, the gridded dots on the gridded surface N and the non-light-in surfaces of the side surfaces W of the LGP may be formed in the following way: by using screen printing method with a material having high reflectivity without light-absorption, diffusing dots are printed on the surface opposite to the light-out surface M (i.e., the gridded surface N) of the LGP 02 and on the non-light-in surface of the side surfaces W thereof. The diffusing dots may be for example round or rectangular. Alternatively, the gridded dots on the gridded surface N and the non-light-in surfaces of the side surfaces W of the LGP may be formed in the following way: when the LGP 02 is ejection molded, a small amount of particles with different refraction indices are added into PMMA, which will directly form some dense tiny protruding dots on the surface opposite to the light-out surface M (i.e., the gridded surface N) of the LGP 02 and on the non-light-in surface of the side surfaces W thereof. As another alternative, etching method may also be used to form gridded dots on the surface opposite to the light-out surface M (i.e., the gridded surface N) of the LGP 02 and on the non-light-in surface of the side surfaces W thereof. The embodiment is not limited to any specific way of forming gridded dots.

In the LGP provided by the embodiment of the invention, the side surfaces of the LGP are made to be inclined, which makes it easier to bond the side reflective sheets to the side surfaces. Moreover, the gridded dots are disposed on non-light-in surfaces of the side surfaces. Thus, both the gridded surface and the side reflective sheets are used to reflect light, allowing light to exit from the light-out surface of the LGP. As a result, in comparison to conventional LGP with ever narrowing side surfaces which makes it difficult to bond side reflective sheets to the side surfaces of the LGP and poor reflective effect by using the frame to reflect light, the embodiment of the invention can easily bond the side reflective sheets to the side surface, thereby increasing the reflection effect to light and the light utilization efficiency.

FIG. 5 schematically illustrates a configuration of a backlight unit 05 in accordance with an embodiment of the invention. With reference to FIG. 5, the backlight unit 05 comprises the LGP 02 of FIG. 2, a frame 051 and a lamp group (not shown in FIG. 5).

The LGP 02 comprises a light-out surface M, a gridded surface N disposed opposite to the light-out surface M and having gridded dots disposed thereon, and side surfaces W intersecting both the light-out surface M and the gridded surface N. Non-incidental surfaces of the side surfaces W of the LGP 02 have gridded dots disposed thereon. The frame 051 is disposed on the side surfaces of the LGP 02. The group of lamps is configured for emitting light. Next, the light is reflected by the gridded surface N as well as the side surfaces W having gridded dots disposed thereon of the LGP 02 and then leaves from the light-out surface M.

For example, the side surfaces W of the LGP 02 are perpendicular to the light-out surface M. Alternatively, the side surfaces W of the LGP 02 have inclination angles relative to the light-out surface M. FIG. 5 illustrates an example where the side surfaces W of the LGP 02 have inclination angles relative to the light-out surface M, and the inclination angles are smaller than 90 degrees. As illustrated in FIG. 5, when the side surfaces W of the LGP 02 have inclination angles relative to the light-out surface M, to make the side surfaces W of the LGP 02 to closely contact the frame 051, a contact surface between the frame 051 and the LGP 02 is configured to be parallel to the side surfaces W of the LGP.

As an example, the lamp group may be disposed between the frame 051 and any one of the side surfaces W of the LGP 02 (i.e., the light-in surface of the side surfaces). It may also be disposed on the side having the gridded surface N of the LGP 2. When the lamp group is disposed between the frame 051 and the light-in surface of the side surfaces W of the LGP 02, the backlight unit 05 is referred to as an edge-lit backlight unit. When the lamp group is disposed on the side having the gridded surface N of the LGP 2, the backlight unit 05 is referred to a direct-lit backlight unit. For example, the lamp group comprises a plurality of light bars, which may be disposed as an array between the frame 051 and any one of the side surfaces W of the LGP 02 (i.e., the light-in surface of the side surfaces). As an example, a light groove may be provided on the light-in surface of the side surfaces of the LGP 02. The light groove may be used to fix the light bars between the frame 051 and the light-in surface of the side surfaces W of the LGP 02. Alternatively, the lamp group may be also fixed in other ways, which will not be limitative to the embodiment of the invention.

As an example, the frame 051 may be disposed at a level higher than that of the light-out surface M, or be flush with the level of the light-out surface M. FIG. 5 illustrates that the frame 051 is at a level higher than that of the light-out surface M. In this case, the part of frame 051 which is higher than the light-out surface M may be referred to as a barrier, such as a U-shaped barrier shown in FIG. 5. As backlight units in smart phones and tablet PCs generally do not comprise a barrier, the backlight unit provided by the invention is more suitable to smart phones and tablet PCs when the frame 051 is flush with the level of the light-out surface M.

The embodiment of the invention provides such a backlight unit which comprises: a light guide plate, a frame and a group of lamps. The light guide plate comprises: a light-out surface, a gridded surface configured as being opposite to the light-out surface and having gridded dots disposed thereon, and side surfaces which intersect both the light-out surface and the gridded surface. Gridded dots are disposed on non-light-in surfaces of the side surfaces of the LGP. The group of lamps is configured for emitting light. The light is reflected by the gridded surface as well as the side surfaces having gridded dots disposed thereon of the LGP, and then the reflected light leaves from the light-out surface of the LGP. The LGP provided by the embodiment disposes gridded dots on non-light-in surface of the side surfaces of the LGP, thereby reflecting light and allowing light to exit from the light-out surface of the LGP. By this means, even the side surfaces of the LGP get ever narrower, making it difficult to bond side reflective sheets to the side surfaces of the LGP, the effect of reflecting light is still realized without bonding side reflective sheets, thereby increasing the light usage efficiency.

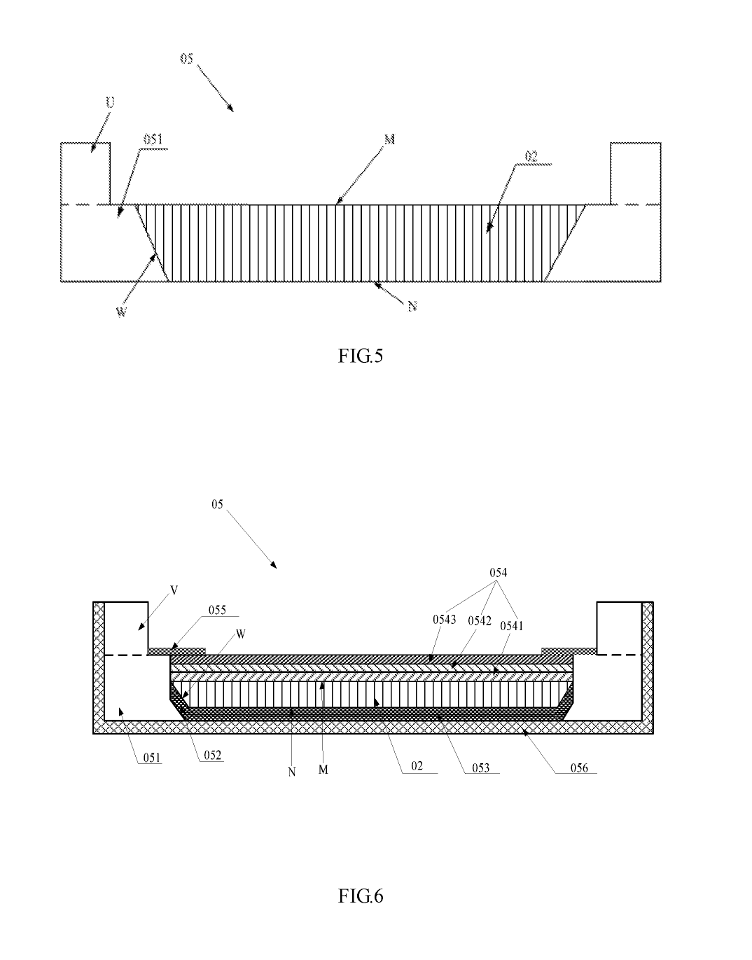

FIG. 6 schematically illustrates a configuration of another backlight unit 05 in accordance with an embodiment of the invention. The backlight unit 05 has additional components in comparison of the backlight unit of FIG. 5, such that better luminescence effect can be achieved. With reference to FIG. 6, the backlight unit 05 further comprises side reflective sheets 052.

As an example, each of the side reflective sheets 052 is disposed between the side surface W of the LGP 05 and the frame 051. The side reflective sheets 052 is configured for reflecting light emitted from the side surface W of the LGP 02, such that the light emitted from the side surface W of the LGP 02 can enter the LGP 02 again and then exits from the light-out surface M of the LGP 02.

As the contact surface between the frame 051 and the LGP 02 is parallel to the side surface W of the LGP 02, and the side reflective sheet 052 is disposed between the side surface W of the LGP 052 and the frame 051, a contact surface between the frame 051 and the side reflective sheet 052 is parallel to the side surface W of the LGP 02.

For example, as illustrated in FIG. 6, the backlight unit 05 further comprises a bottom reflective sheet 053.

For example, the bottom reflective sheet 053 is disposed on the side having the gridded surface N of the LGP 02. To facilitate the assembly of the side reflective sheet 052, the bottom reflective sheet and the side reflective sheets are an integral structure.

For example, as illustrated in FIG. 6, the backlight unit 05 further comprises an optical film group 054 and a light-shielding sheet 055.

For example, the optical film group 054 is disposed on a side having the light-out surface M of the LGP 02. In practical applications, the optical film group 054 typically comprises a diffuser sheet 0541, a prism sheet 0542 and a protective sheet 0543. The diffuser sheet 0541 is disposed on the side having the light-out surface M of the LGP 02, the prism sheet 0542 is disposed on the side away from the LGP of the diffuser sheet 0541, and the protective sheet 0543 is disposed on a side away from the diffuser sheet of the prism sheet 0542. The diffuser sheet 0541 can regulate light exit from the light-out surface M of the LGP 02, making the light passing through the diffuser sheet 0541 more homogeneous, increasing the quality of the backlight unit. The prism sheet 0542 may be for example made up of an upper prism and a lower prism stacked together, or may be a transparent plastic film, the sheet 0542 has a thickness between 50 nm to 300 nm. An upper surface of the prism sheet 0542 is evenly covered with a layer of prism structure, and the prism sheet 0542 is disposed on the side away from the LGP of the diffuser sheet 0541, which can change angles of the light by converging light scattered to various angles and emitted from the diffuser sheet 0541 to an axial angle, thereby increasing the axial brightness without increasing the overall light flux. The protective sheet 0543 is configured for protecting the prism sheet 0542 as well as the diffuser sheet 0541 and the LGP 02 arranged behind the prism sheet 0542. Configurations of the diffuser sheet 0541, the prism sheet 0542 and the protective sheet 0543 are known to those skilled in the art and will not be elaborated here.

The light shielding sheet 055 is disposed at an edge of the optical film group 054 which is away from the LGP 02, and an orthographic projection of the side surfaces W of the LGP 02 on the light-out surface M falls within a coverage area of the light-shielding sheet 055. The provision of the light shielding sheet 055 can prevent the light leaking from the optical film group 054 (e.g., from the protective sheet 0543), thereby preventing light leakage of a display device comprises the backlight unit.

For example, the backlight unit 05 may further comprise a steel frame 056. The steel frame is disposed outside the frame 051. The structure and function of the steel frame 056 are known to those skilled in the art and will not be limitative to the embodiment.

As an example, the frame 051 may be disposed at a level higher than that of the surface of the protective sheet 0543 which is away from the LGP 02, or be flush with the level of the surface of the protective sheet 0543 which is away from the LGP 02.

When the frame 051 is higher than the level of the surface of the protective sheet 0543 which is away from the LGP 02, the backlight unit 05 is as shown in FIG. 6. In this case, the part of frame 051 which is higher than the level of the surface of the protective sheet 0543 which is away from the LGP 02 may be referred to as a barrier, such as the barrier “V” shown in FIG. 6.

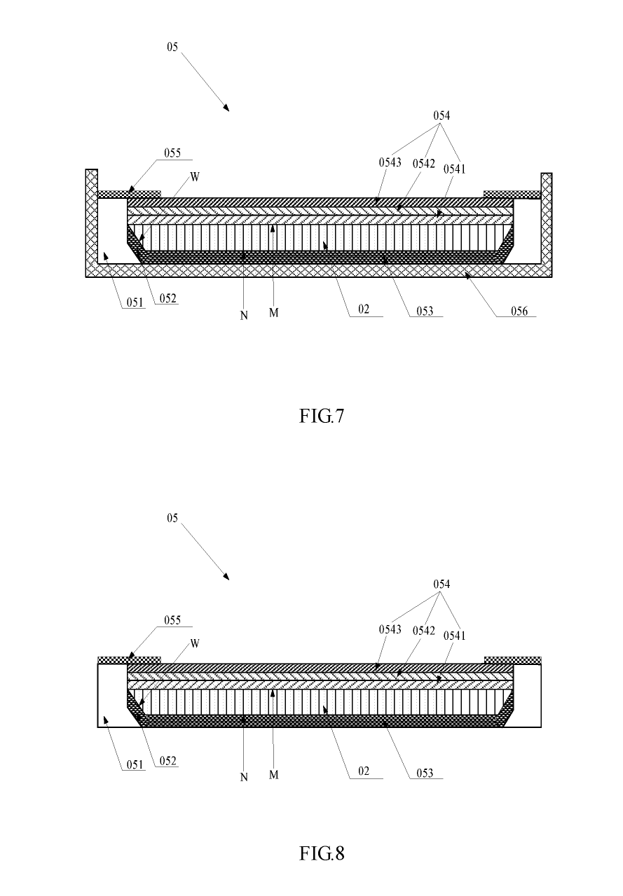

When the frame 051 is flush with the level of the surface of the protective sheet 0543 which is away from the LGP 02, the backlight unit 05 is shown in FIG. 7. With reference to FIG. 7, the frame 051 is flush with the level of the surface of the protective sheet 0543 which is away from the LGP 02, the light shielding sheet 055 is configured as overlaying both the frame 051 and an edge of a surface of the optical film group 054 which is away from the LGP 02.

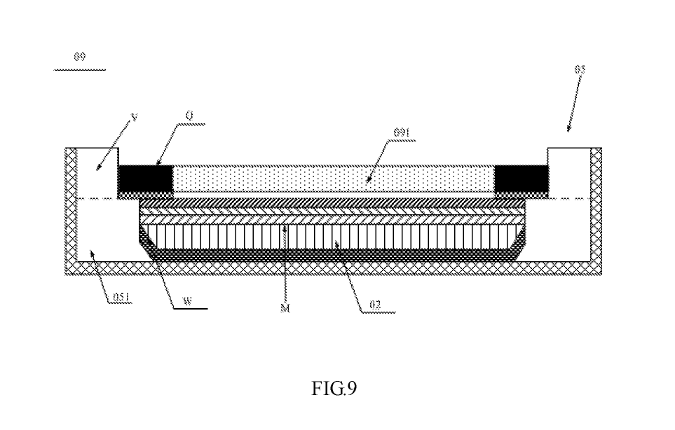

The embodiment is described with reference to an example where the backlight unit 05 comprises the steel frame 056. In fact, the backlight unit may not comprise a steel frame but comprises only the LGP 02, the lamp group, the side reflective sheet 052, the bottom reflective sheet 053, the optical film group 054 and the light shielding sheet 055. In this case, the backlight unit 05 has a configuration as illustrated in FIG. 8. In FIG. 8, the frame 051 does not comprise a barrier, and the backlight unit 05 does not comprise a steel frame. As backlight units in smart phones and tablet PCs generally do not comprise a barrier or steel frame, the backlight unit 05 provided by FIG. 8 is more suitable to smart phones and tablet PCs.

The embodiment of the invention provides such a backlight that comprises: a light guide plate, a frame and a lamp group. The light guide plate comprises: a light-out surface, a gridded surface configured as being opposite to the light-out surface and having gridded dots disposed thereon, and side surfaces which intersect both the light-out surface and the gridded surface. The side surfaces have inclination angles relative to the light-out surface, and gridded dots are disposed on non-light-in surfaces of the side surfaces of the light guide plate. The lamp group is configured for emitting light. The light is reflected by the gridded surface as well as the side surfaces having gridded dots disposed thereon of the light guide plate, and then the reflected light leaves from the light-out surface of the LGP. The embodiment of the invention configures the side surfaces of the LGP as inclined surfaces, such that it is easier to bond the side reflective sheets to the side surfaces of the LGP. Moreover, the gridded dots are disposed on non-light-in surface of the side surfaces of the LGP, thereby reflecting light and allowing light to exit from the light-out surface of the LGP, by using the surfaces with the gridded dots and the side reflective sheets. In comparison to conventional LGP with ever narrowing side surfaces which makes it difficult to bond side reflective sheets to the side surfaces of the LGP and poor reflective effect by using the frame to reflect light, the embodiment of the invention can easily bond the side reflective sheets to the side surface, thereby increasing the reflection effect to light and increasing the light utilization efficiency.

FIG. 9 schematically illustrates a configuration of a display device 09 in accordance with an embodiment of the invention. The display device comprises a display panel 091 and a backlight unit 05. For example, a black sealing region Q is arranged at peripheral regions of the display panel 091. The backlight unit 05 may be any one of the backlight unit shown in FIGS. 5 to 8. The embodiment is described with reference to a display device comprising the backlight unit of FIG. 6. When the display device comprises the backlight unit of FIG. 5, 7 or 8, reference is made to this embodiment. For example, an area of the black sealing region Q is larger than or equal to an area of an orthographic projection of the side surfaces W of LGP 02 on the light-out surface M.

The display device 09 is for example a liquid display panel, an E-paper, an Organic Light-Emitting Diode (OLED) panel, a mobile phone, a tablet PC, a television, a display, a notebook PC, a digital photoframe, a navigator and any other product or component having a display function.

The backlight unit 05 provided by the embodiment of the invention is also applicable to dual-display devices, which have display panels on both the light-out surface and the gridded surface of the LGP, to achieve dual-screen display of dual-screen LCDs. When the backlight unit 05 is applied to a dual-screen LCD, the implementation is identical or similar to the embodiment, which will not be elaborated here.

The embodiment is described with reference to an example where the frame 051 of the backlight unit 05 comprises a barrier V and the backlight unit 05 comprises a steel frame 056. For implementation of display devices where the frame 051 does not comprise a barrier V and the backlight unit 05 does not comprise a steel frame 056, reference is made to the embodiment, which will not be elaborated here.

The display device provided by the embodiment of the invention comprises a display panel and a backlight unit. The backlight unit comprises: a light guide plate, a frame and a lamp group. The light guide plate comprises: a light-out surface, a gridded surface configured as being opposite to the light-out surface and having gridded dots disposed thereon, and side surfaces which intersect both the light-out surface and the gridded surface. The side surfaces have inclination angles relative to the light-out surface, and gridded dots are disposed on non-light-in surfaces of the side surfaces of the light guide plate. The lamp group is configured for emitting light. The light is reflected by the gridded surface as well as the side surfaces having gridded dots disposed thereon of the light guide plate, and then the reflected light leaves from the light-out surface of the LGP. The display device according to the embodiment of the invention configures the side surfaces of the LGP as inclined surfaces, such that it is easier to bond the side reflective sheets to the side surfaces of the LOP. Moreover, the gridded dots are disposed on non-light-in surface of the side surfaces of the LOP, thereby reflecting light and allowing light to exit from the light-out surface of the LGP, by using the surfaces with the gridded dots and the side reflective sheets. In comparison to conventional LGP with ever narrowing side surfaces which makes it difficult to bond side reflective sheets to the side surfaces of the LGP and poor reflective effect by using the frame to reflect light, the display device according to the embodiment of the invention can easily bond the side reflective sheets to the side surface, thereby increasing the reflection effect to light and increasing the light utilization efficiency.

What is described above is related to the illustrative embodiments of the disclosure only and not limitative to the scope of the disclosure; the scopes of the disclosure are defined by the accompanying claims.

The present application claims priority from Chinese Application No. 201510189058.X, filed on Apr. 20, 2015, the disclosure of which is incorporated herein by reference in its entirety.

1. A light guide plate, comprising: a light-out surface, a gridded surface configured as being opposite to the light-out surface and having gridded dots disposed thereon, and side surfaces intersecting both the light-out surface and the gridded surface,
wherein gridded dots are disposed on a non-light-in surface of the side surfaces of the light guide plate.

2. The light guide plate of claim 1, wherein the side surfaces of the light guide plate are perpendicular to the light-out surface; or the side surfaces of the light guide plate have inclination angles relative to the light-out surface thereof.

3. The light guide plate of claim 1, wherein the gridded dots are made of a material having a high reflectivity without light-absorption.

4. A backlight unit, comprising: a light guide plate, a frame and a lamp group,
wherein the light guide plate comprises: a light-out surface, a gridded surface configured as being opposite to the light-out surface and having gridded dots disposed thereon, and side surfaces intersecting both the light-out surface and the gridded surface, wherein gridded dots are disposed on a non-light-in surface of the side surfaces of the light guide plate;
the frame is disposed outside the side surfaces of the light guide plate;
the lamp group is configured for emitting light, such that the light is reflected by the gridded surface as well as the side surfaces having gridded dots disposed thereon of the light guide plate, and then the reflected light leaves from the light-out surface of the LGP.

5. The backlight unit of claim 4, wherein the side surfaces of the light guide plate are perpendicular to the light-out surface, or the side surfaces of the light guide plate have inclination angles relative to the light-out surface.

6. The backlight unit of claim 5, further comprising: side reflective sheets, wherein each of the side reflective sheets is disposed between one of the side surfaces of the light guide plate and the frame and configured for reflecting light emitted from the side surface of the light guide plate.

7. The backlight unit of claim 6, wherein a contact surface between the frame and the side reflective sheet is parallel to the side surface of the light guide plate.

8. The backlight unit of claim 4, further comprising: a bottom reflective sheet, wherein the bottom reflective sheet is disposed on a side of the light guide plate having the gridded surface.

9. The backlight unit of claim 8, further comprising: side reflective sheets, wherein each of the side reflective sheets is disposed between one of the side surfaces of the light guide plate and the frame and configured for reflecting light emitted from the side surface of the light guide plate;
the bottom reflective sheet and the side reflective sheets are an integral structure.

10. The backlight unit of claim 4, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.

11. The backlight unit of claim 10, wherein the optical film group comprises at least one of a diffuser sheet, a prism sheet and a protective sheet.

12. The backlight unit of claim 4, wherein the gridded dots are made of a material having a high reflectivity without light-absorption.

13. A display device comprising a display panel and the backlight unit of claim 4.

14. The display device of claim 13, wherein the display panel comprises a black sealing region arranged at peripheral regions of the display panel, an area of the black sealing region is larger than or equal to an area of an orthographic projection of the side surfaces of the light guide plate on the light-out surface.

15. The backlight unit of claim 5, further comprising: a bottom reflective sheet, wherein the bottom reflective sheet is disposed on a side of the light guide plate having the gridded surface.

16. The backlight unit of claim 5, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.

17. The backlight unit of claim 6, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.

18. The backlight unit of claim 7, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.

19. The backlight unit of claim 8, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.

20. The backlight unit of claim 9, further comprising an optical film group and a light-shielding sheet, wherein
the optical film group is disposed on a side of the light guide plate having the light-out surface;
the light shielding sheet is disposed at an edge of a surface of the optical film group which is away from the light guide plate, and an orthographic projection of the side surfaces of the light guide plate on the light-out surface falls within a coverage area of the light-shielding sheet.
